(19) United States
(12) Patent Application Publication
(10) Pub. No.: US 2021/0209661 A1
(43) Pub. Date: Jul. 8, 2021

(54) PEER-TO-PEER CONSUMER REVIEW TECHNIQUES

(71) Applicant: Nora Wang Na Esram, McLean, VA (US)

(72) Inventor: Nora Wang Na Esram, McLean, VA (US)

(21) Appl. No.: 17/142,235

(22) Filed: Jan. 5, 2021

Related U.S. Application Data
(60) Provisional application No. 62/957,301, filed on Jan. 5, 2020.

(51) Int. Cl. G06Q 30/02; G06F 16/9535; G06Q 30/06

(52) U.S. Cl. CPC G06Q 30/0282; G06Q 30/0627; G06F 16/9535

(57) ABSTRACT

Peer-to-peer consumer review techniques are disclosed. In one particular embodiment of the present disclosure, the techniques may be realized as peer-to-peer consumer review method comprising: receiving, by a system comprising memory and one or more processors, characteristics of the product; receiving, by the system, review opinions of the product from reviewers; receiving, by the system, attributes of the reviewers; storing, by the system, the characteristics, the review opinions, and the attributes in a storage device; determining, by the system, a correlation between one of the review opinions with a set of one or more of the attributes and a set of one or more of the characteristics; storing, by the system, the correlation in the storage device; and using, by the system, the correlation to provide a predicted review opinion to a consumer, present another product to the consumer, or remove a review opinion from the storage device.

### CROSS-REFERENCE TO RELATED APPLICATION

This application claims the priority benefit from U.S. Provisional Application No. 62/957,301, filed Jan. 5, 2020, the entire contents and disclosures of which are hereby incorporated herein by reference.

### FIELD OF THE DISCLOSURE

The present disclosure relates generally to peer-to-peer consumer review techniques.

### BACKGROUND

Ecommerce has been growing tremendously in recent years. With widespread internet access and a rising number of consumers from the younger generation (gen xyz and millennials, born after 1970s) who are more familiar with the internet than the baby boomers (born in the 40s-60s), online shopping may soon become the mainstream method of purchasing. Forty percent (40%) of worldwide internet users have bought products or goods online. This amounts to more than 1 billion online buyers. Compared with traditional shopping in a brick-and-mortar store, consumers have no physical contact with online products or services and rely on pictures and descriptions to judge the quality and function of a product or service. Eighty seven percent (87%) of shoppers today use ecommerce reviews to decide whether to buy. However, there are many issues with the existing consumer review systems.

Lack of review: Many consumers are not motivated to write a review unless they are incentivized by the sellers or service provider (such as receiving it a future discount or winning a gift card in exchange) or prompted by an extremely good or bad experience with the product or the service. Many products or services have no review at all or only a few reviews, which are more likely subject to biased opinions.

Difficult to navigate: Even if abundant reviews are available for popular products or services, it is very time consuming for a consumer to navigate through hundreds or thousands of reviews. Reviews currently can be sorted based on time created or ranking of ratings (such as number of stars received). It can be difficult to find the right information because people with different cultural background, socioeconomic status, lifestyles, and experience with similar products or services often have different opinions and evaluations of the same product or service. This challenge is more predominant for personal products that are more tailored to individual bodies such as clothes, food, and skin care products.

Controlled by sellers: When reviews are posted on a seller's website, the seller has control over the review contents. In some cases, mostly positive reviews are posted to promote sales, while negative reviews are censured

Untruthful reviews: Product or service review has become a main income source of some online bloggers or social-media influencers. Many of these reviews do not reflect the true quality of a product or service when the reviewers are sponsored by the sellers. Reviewers are not obligated to disclose the sponsorships to the consumers. Their truthfulness depends on their ethical conduct. Independent third-party consumer reports exist, but they only cover a small number of products or services and are often not provided gratis. Furthermore, online review systems typically do not have an easy verification process and leave a loophole for sellers or hackers to post a large number of fake reviews to mislead the consumers. It has been reported that many reviews cannot be trusted because fake reviews have flooded popular e-commerce sites. These reviews are purchased in large private internet groups to deceive consumers and increase sales. Although these fake reviews are removed by the host site when detected, it is a constant battle for big companies and a losing battle for small companies that do not have tools or resources to combat review fraud.

Low market efficiency: Ineffective consumer review systems result in unpleasant consumer experience and an inefficient market. Many sellers offer free shipping and free returns (back to the warehouses or the local brick-and-mortar stores if such stores exist) to reduce consumers' risks of purchasing unsatisfying products. It is a waste of resources for sellers (extra labor cost to handle restocking and additional shipping cost) if buyers make the wrong buying decision based on misleading reviews. The average return rate of ecommerce is 20%, compared to 8-10% in brick-and-mortar stores. The buyers also have to take extra time to return a product and wait for a refund, let alone the possible disputes during the process. Moreover, many smaller sellers cannot afford offering free shipping and returns. Additional shipping and restocking fees make their products less attractive and less competitive. A consumer survey in 2018 showed that 62% of consumers would buy again from a brand offering free returns or exchanges. Therefore, the unfair competition favors more established online sellers.

In view of the above shortcomings with conventional consumer review systems, this invention aims at creating more reliable and efficient peer-to-peer (P2P) consumer review techniques to increase the credibility of the reviews, minimize fraud, give consumers incentives to provide truthful reviews, reduce product returns, and create a more pleasant online shopping experience.

### SUMMARY OF THE DISCLOSURE

Peer-to-peer consumer review techniques are disclosed. In one particular embodiment of the present disclosure, the techniques may be realized as peer-to-peer consumer review method comprising: receiving, by a system comprising memory and one or more processors, characteristics of the product; receiving, by the system, review opinions of the product from reviewers; receiving, by the system, attributes of the reviewers; storing, by the system, the characteristics, the review opinions, and the attributes in a storage device; determining, by the system, a correlation between one of the review opinions with a set of one or more of the attributes and a set of one or more of the characteristics; storing, by the system, the correlation in the storage device; and using, by the system, the correlation to provide a predicted review opinion to a consumer, present another product to the consumer, or remove a review opinion from the storage device.

In accordance with other aspects of this particular embodiment, the peer-to-peer consumer review method further comprises receiving, by the system, attributes of the consumer; predicting, by the system and based on a determination of the attributes of the consumer that fall in the set of the one or more of the attributes, the predicted review opinion using the correlation stored in the storage device and the attributes of the consumer that fall in the set of the one of more of the attributes; and providing, by the system, the predicted review opinion to the consumer.

In accordance with other aspects of this particular embodiment, the peer-to-peer consumer review method further comprises receiving, by the system, characteristics of the another product; receiving, by the system, attributes of the consumer; predicting, by the system and based on a determination of the attributes of the consumer that fall in the set of the one or more of the attributes and a determination of the characteristics of the another product that fall in the set of the one or more of the characteristics, the predicted review opinion using the correlation stored in the storage device, the attributes of the consumer that fall in the set of the one of more of the attributes, and the characteristics of another product that fall in the set of the one or more of the characteristics; and presenting, by the system, the another product and the predicted review opinion to the consumer.

In accordance with other aspects of this particular embodiment, the peer-to-peer consumer review method further comprises receiving, by the system, new review opinions of the product from a new reviewer; receiving, by the system, new attributes of the new reviewer; combining, by the system, the new review opinions with the stored review opinions; combining, by the system, the new attributes with the stored attributes; storing, by the system, the combined review opinions and the combined attributes in the storage device; determining, by the system, another correlation between one of the combined review opinions with a set of one or more of the combined attributes and a set of one or more of the characteristics; and replacing, by the system, the stored correlation with the another correlation in the storage device.

In accordance with other aspects of this particular embodiment, the peer-to-peer consumer review method further comprises receiving, by the system, new review opinions of the product from one of the reviewers; combining, by the system, the new review opinions with the stored review opinions; storing, by the system, the combined review opinions in the storage device; determining, by the system, another correlation between one of the combined review opinions with a set of one or more of the attributes and a set of one or more of the characteristics; and replacing, by the system, the stored correlation with the another correlation in the storage device.

In accordance with other aspects of this particular embodiment, the peer-to-peer consumer review method further comprises receiving, by the system, new review opinions of another product from one of the reviewers; receiving, by the system, new attributes from the one of the reviewers; determining, by the system, an inconsistency between the new attributes with the stored attributes of the one of the reviewers; flagging, by the system and based on the determined inconsistency, the new review opinions and the stored review opinions corresponding to the one of the reviewers; flagging, by the system and based on the determined inconsistency, the one of the reviewers; removing, by the system, the stored review opinions corresponding to the one of the reviewers from the storage device; removing, by the system, the stored attributes corresponding to the one of the reviewers from the storage device; determining, by the system, another correlation between the one of the review opinions with the set of the one or more of the attributes and the set of the one or more of the characteristics; and storing, by the system, the another correlation in the storage device.

In accordance with other aspects of this particular embodiment, the peer-to-peer consumer review method further comprises determining, by the system, another correlation between another one of the review opinions with another set of one or more of the attributes and the set of one or more of the characteristics or another set of one or more of the characteristics; and storing, by the system, the another correlation in the storage device.

In accordance with other aspects of this particular embodiment, the product is one of an apparel, a service, a hardware, and a vehicle.

In accordance with other aspects of this particular embodiment, the attributes of the reviewers include one or more of gender, age, body measurements, ethnicity, cultural background, lifestyle, and spending habit.

In accordance with other aspects of this particular embodiment, the characteristics of the product include one or more physical dimensions, shape, color, functions, electrical ratings, mechanical ratings, and firmness.

In accordance with other aspects of this particular embodiment, the review opinions include one or more of fit, big, small, tight, loose, long, short, high-quality, low quality, and comfortable.

In another particular embodiment of the present disclosure, the techniques may be realized as a peer-to-peer consumer review system comprising one or more processors and memory storing instructions that, when executed by the one or more processors, cause the peer-to-peer consumer review system to perform the steps of the above-described peer-to-peer consumer review method.

In yet another particular embodiment of the present disclosure, the techniques may be realized as a non-transitory computer-readable medium storing executable instructions that, when executed by one or more processors, cause a peer-to-peer consumer review system to perform the steps of the above-described peer-to-peer consumer review method.

The present disclosure will now be described in more details with reference to particular embodiments thereof as shown in accompanying drawings. While the present disclosure is described below with reference to particular embodiments, it should be understood that the present disclosure is not limited thereto. Those of ordinary skill in the art having access to the teachings herein will recognize additional implementation, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate the understanding of the present disclosure, reference is now made to the accompanying drawings. These drawings should not be construed as limiting the present disclosure, but are intended to be illustrative only.

FIG. 1 depicts the operation of a peer-to-peer consumer review system according to an embodiment of the present disclosure.

FIGS. 2-8 show flow diagrams of peer-to-peer consumer review methods according to embodiments of the present disclosure.

FIG. 9 illustrates an architecture for the implementation of a peer-to-peer consumer review system according to an embodiment of the present disclosure.

### DETAILED DESCRIPTION

According to an embodiment of the present disclosure, a P2P consumer review system may use consumer profile matching and machine learning to connect consumers with most relevant reviews of products and services. Hereinafter, products and services may be used interchangeably, or products may be understood to generally include services. Consumer profiles may include consumers' attributes such as cultural background, lifestyle, spending habit, personal preference, body measurement, and any other information that consumers are willing to share in order to increase review matching. The P2P consumer review system may use machine learning to determine correlations between review opinions, consumer attributes and product characteristics (e.g., dimensions, size, shape, color, firmness, functions, quality, electrical or mechanical ratings, friendliness, politeness, etc.). A review opinion is a consumer's subjective evaluation of a product characteristic. A consumer can provide multiple opinions on multiple characteristics of one product in one review. To protect consumer privacy, the P2P consumer review system may encrypt consumer profiles for matching and corelating purposes, making the consumer profiles invisible to the public or sellers. The P2P consumer review system may continuously refine consumer profiles automatically based on the corresponding consumers' shopping history, past reviews, and/or ongoing feedback about products bought or services received. As consumer profiles are developed and refined over time, the machine learning algorithm self-calibrates and evolves to create more accurate matching of consumer profiles and more accurate correlations with the review opinions and characteristics of the reviewed products. This is fundamentally different from conventional product searching and content matching methods that use consumers' browsing, searching, or purchasing histories to make buying suggestions and push advertisements to the consumers. For example, current online shopping websites often display similar products through “people who view this product also view those products like . . . ” or “these products are often bought together.”

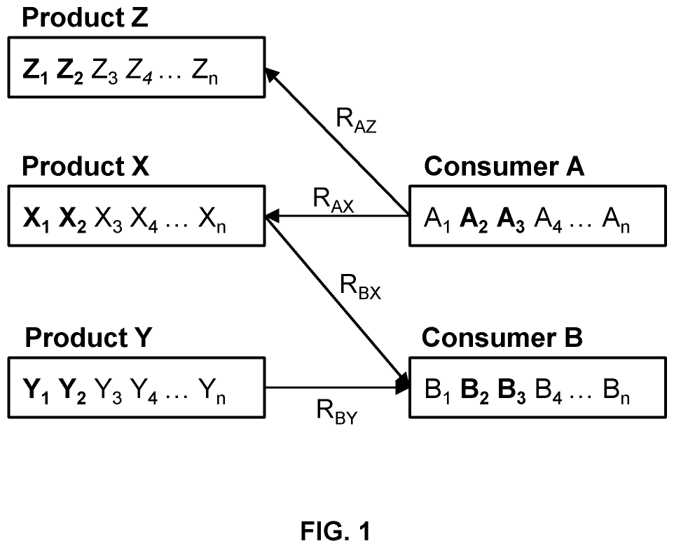

FIG. 1 illustrates the matching and correlation functions of the P2P consumer review system, according to an embodiment of the present disclosure. Product X may have characteristics X₁, X₂, X₃, X₄, . . . , Xₙ. Similarly, Product Y may have characteristics Y₁, Y₂, Y₃, Y₄, . . . , Yₙ and Product Z may have characteristics Z₁, Z₂, Z₃, Z₄, . . . , Zₙ. Consumer A may have a profile with attributes A₁, A₂, A₃, A₄, . . . , Aₙ. Similarly, Consumer B may have a profile with attributes B₁, B₂, B₃, B₄, . . . , Bₙ. Consumer C (not shown in FIG. 1) may have a profile with attributes C₁, C₂, C₃, C₄, . . . , Cₙ, and so on. After a consumer provides a review on a product, the consumer may be called a “reviewer.” The review may have multiple review opinions R₁, R₂, R₃, R₄, . . . , Rₙ.

In FIG. 1, based on Consumer A's (a reviewer) review of Product X, the P2P consumer review system may find attributes A₂ and A₃ to correlate to a positive or negative review opinion R_{AX} of characteristics X₁ and X₂. This correlation may be expressed with coefficients a, b, c, d representing marginal effects (i.e., relative contributions) of the independent variables (i.e., consumer/reviewer attributes or product characteristics) on the target variable (i.e., review opinion):

R_{AX}=f(a·A₁, b·A₂, c·X₁, d·X₂)

In the above equation, all variables may be categorical or discrete, and f( ) implies that R_{AX} is a function of a·A₁, b·A₂, c·X₁, and d·X₂.

The P2P consumer review system may strengthen and verify this correlation based on information about other consumers who also have attributes similar to A₂ and A₃ and who also like (positive review) product characteristics similar to X₁ and X₂. Improvement of correlation may be achieved by modifying the coefficients (i.e., a, b, c, d) (e.g., by machine learning) to result in a better prediction of review outcome (R_{X}). Thereafter, if Consumer B has attributes B₂ and B₃ that are respectively similar to A₂ and A₃, the P2P consumer review system may predict Consumer B's opinion (R_{BX}) on Product X (if Consumer B were to use the product) and recommend Product X to Consumer B with confidence (if the predicted opinion is positive). The predicted opinion may be expressed as:

R_{BX}=f(a·B₁, b·B₂, c·X₁, d·X₂)

Consumer B may also read Consumer A's review to ensure that what he or she cares about Product X (likely characteristics X₁ and X₂) is reflected in the review and make an informed purchase decision.

Alternatively, if Product Y that has characteristics Y₁ and Y₂ that are respectively similar to characteristics X₁ and X₂, the P2P consumer review system may predict Consumer B's opinion (R_{BY}) on Product Y and provide Consumer B with a confident recommendation. The predicted opinion may be expressed as:

R_{BY}=f(a·B₁, b·B₂, c·Y₁, d·Y₂)

A similar logic may apply to negative reviews. For example, if the P2P consumer review system finds characteristic Z₄ of Product Z to be a significant contributing factor that makes Consumer A dislike Product Z, it will not recommend Product Z to Consumer B, even if characteristics Z₁ and Z₂ are similar to characteristics X₁ and X₂. The correlation may be expressed as:

R_{AZ}=f(e·A₁, f·A₂, g·Z₄)

Such a P2P consumer review system may minimize the impact of fake reviews or totally block fake reviews. Fake reviews by sponsored reviewers or bots (such as purchased review datasets) may be easily eliminated from the matched review because they do not pass profile validation when a review does not match its reviewer's profile or the “non-existent reviewer” does not even have a profile. If a reviewer writes a review that includes attributes that are conflicting with the existing attributes of the reviewer, the P2P consumer review system may block such review from the pool of reviews, data, or information that the machine learning algorithm considers in matching consumer profiles and correlating with review opinions and product characteristics. A consumer's profile is a combination of personal attributes that affect his or her purchasing decision and evaluation (subjective opinion) of a product, just like genes play a significant role in one's behaviors or choices. Although some personal preferences or life choices may change with time or context (such as socio-economic status) and one person can have a broad interest or changing opinions, it is very unlikely that one person would favor every style, every color, or every activity at the same time, just like his or her body shape cannot fit into any garment silhouettes at the same time.

For example, consider a scenario where Consumer A reviews Product X, a garment that fits Consumer A's body measurement and style (i.e., Consumer A's profile). If Consumer B has a similar profile to Consumer A, and Consumer C has a totally different profile to Consumer A, the P2P consumer review system will show Consumer A's review of Product X to Consumer B, but not to Consumer C, essentially recommending Product X to Consumer B by predicting Consumer B's opinion of Product X based on Consumer A's review. If Consumer A chooses to write a fake review of Product X, the P2P consumer review system may not yet detect that it is a fake review, but the fake review will only impact Consumer B, not Consumer C.

Now consider a different scenario where Consumer A writes a positive but untruthful review of Product Y, another garment that does not fit Consumer A's profile. The review indicates some new attributes that support a positive review of Product Y but conflict with Consumer A's existing attributes. Examples of mutually exclusive attributes that one consumer is unlikely to have at the same time could be gender (being male and female), age group (being young and old), body proportion (being a small chest and a large chest). More subtle conflicting attributes could be minimalist and maximalism, or formal and hippie. Although it is possible for one person to favor two dramatically different styles, the credibility of reviews from reviewers with conflicting attributes is low or at least, less representative. Here, the P2P consumer review system may automatically detect and delete these low credibility reviews from the pool available to the machine learning algorithm. Furthermore, the P2P consumer review system may reduce Consumer A's credibility by ceasing to show Consumer A's review(s) to Consumer B and other consumers.

To illustrate how the P2P consumer review system may work, apparel shopping will now be used as an example. Clothes or shoes fitting is usually tailored to a body type and personal lifestyle. Valuation of comfort and material quality depends on one's personal preference, living environment, and socioeconomic status. Buying clothes or shoes purely based on pictures of professional models (who typically are taller and skinnier than an average person) and/or based on the unstandardized sizing charts provided by the manufacturer is often unsuccessful. Reviews from other online shoppers are not much better unless these shoppers' body fits and styles are available for comparison.

Accordingly, the P2P consumer review system may first create a body measurement record and a preliminary style profile for every consumer who participates in the P2P consumer review system to review products and/or receive recommendations. A consumer's profile may evolve in the P2P consumer review system based on the consumer's apparel shopping history and reviews. When an online shopper wants to know if a specific garment fits him or her, the P2P consumer review system may filter the pool of reviewer attributes, predict the fitting (based on the correlation of review opinions with the garment characteristics and review attributes), and present review opinions from other consumers who have the same or similar body measurements and style choices.

In conventional consumer review systems, by simply reading a review of a product without any knowledge of the buyer's and reviewer's profile, it is very difficult for a consumer to judge the fitting and quality of the product. For example, if Shoe X has been reviewed by only Consumer A and Consumer B as exemplified in Table I below, it is practically impossible for Consumer C to know which one of the two reviews, if any, would more likely reflect her own view of Shoe X.

TABLE I

| | Consumer A's | Consumer B's |
|---|---|---|
| Shoe X | review | review |
| X₁: Type (Pump) | R_{A2}: Classy, versatile | R_{B2}: Looks nice |
| X₂: Shape | R_{A3}: Goes with my | R_{B3}: Too formal |
| (Pointy Toe) | clothes | R_{B4}: Great Material |
| X₃: Color (Black) | R_{A4}: Good Material | R_{B5}: Hurts my toes |
| X₄ Material | R_{A5}: Comfortable, | R_{B6}: True to size |
| (Leather) | can walk long | R_{B7}: Reasonable price |
| X₅: Heel Height (2″) | R_{A6}: True to size | |
| X₆: Size (7) | R_{A7}: A bargain!!! | |
| X₇: Price ($100) | | |

However, if Consumer C could compare her own profile to Consumer A's profile and Consumer B's profile, as exemplified in Table II below, Consumer C would likely deduce that her profile is more closely matched to Consumer A's profile (e.g., they both prefer formal leather shoes, wear heels, purchase shoes above $100). Therefore, it is more informative for Consumer C to consider Consumer A's review of Shoe X.

TABLE II

| Consumer A's | Consumer B's | Consumer C's |
|---|---|---|
| profile | profile | profile |
| A₁: Type Preference | B₁: Type Preference | C₁: Type Preference |
| (Pump) | (Sneaker) | (Pump) |
| A₂: Style | B₂: Style | C₂: Style |
| (Classy, Formal) | (Casual) | (Formal) |
| A₃: Color | B₃: Color | C₃: Color |
| (Black, Nude) | (Blue, White) | (Black, White) |
| A₄: Material | B₄: Material | C₄: Material |
| Preference (Leather) | Preference (Fabric) | Preference (Leather) |
| A₅: Heel Preference | B₅: Heel Preference | C₅: Heel Preference |
| (3″) | (1″) | (2″) |
| A₆: Size (7-7.5) | B₆: Size (7-7.5) | C₆: Size (7.5-8) |
| A₇: Purchase power | B₇: Purchase power | C₇: Purchase power |
| ($150-$300) | ($50-$100) | ($100-$150) |

Moreover, if Consumer C could validate her match with Consumer A by looking at Consumer A's past reviews, as exemplified in Table III below, and confirming that Consumer A indeed bought and reviewed similar items that are appealing to Consumer C, Consumer A's opinions would have more credibility to Consumer C.

TABLE III

| Review History | Record 1A | Record 2A | Record 3A | | Record nA |
|---|---|---|---|---|---|
| Type | Pump | Pump | Flat | . . . | Sneaker |
| Shape | Pointy toe | Pointy toe | Pointy toe | | Round |
| Color | Black | Nude | Nude | | Black |
| Material | Leather | Leather | Leather | | Leather |
| Heel Height | 3″ | 3.5″ | 1″ | | 1″ |
| Size | 7 | 7 | 7.5 | | 7 |
| Price | $300 | $250 | $150 | | $150 |

Further, if Consumer C could confirm that she should indeed disregard Consumer B's review of Shoe X since Consumer B's purchased items, as exemplified in Table IV, are not of Consumer C's liking, Consumer C would be more confident that her purchasing decision should not be influenced by Consumer B's good or bad review of Shoe X.

TABLE IV

| Review History | Record 1B | Record 2B | Record 3B | | Record nB |
|---|---|---|---|---|---|
| Type | Flat | Pump | Flat | . . . | Sneaker |
| Shape | Round toe | Round toe | Round toe | | Round |
| Color | Blue | Blue | Yellow | | White |
| Material | Fabric | Faux Leather | Fabric | | Fabric |
| Heel Height | 0.5″ | 1″ | 0.5″ | | 1″ |
| Size | 7 | 7 | 7.5 | | 7 |
| Price | $80 | $90 | $50 | | $65 |

The P2P consumer review system performs all of the above functions for Consumer C without sharing any personal information and purchasing histories of Consumer A and Consumer B. Consumer C only needs to make his or her purchasing decision in reference to Consumer A's review automatically provided by the P2P consumer review system. Consumer A and Consumer C may represent a group of consumers who share one or more similar attributes.

A consumer may create or modify his or her profile initially when little or no data about the consumer exists in the P2P consumer review system. Thereafter, the P2P consumer review system may automatically construct and verify the profile over time based on the consumer's purchasing history, reviews, and/or ongoing feedback on products/services bought. The P2P consumer review system may use machine learning to find patterns in the consumer's preferences and body fittings. While it may be possible for someone to change his/her style over time or have a broad preference of various styles, clothes fitting that reflects a consumer's body shape and proportion is unlikely to change dramatically. For example, if a piece of garment fits a long torso (based on most reviews), a positive review of that same garment from someone with a short torso would be viewed as less credible by the P2P consumer review system. Moreover, the P2P consumer review system is able to capture the subjective fitting (i.e., perceived fitting) beyond objective fitting (i.e., body measurement). For example, two people with the same body measurement may physically fit one garment the same way. However, if one prefers a tight silhouette and the other prefers a loose silhouette, they may arrive at different conclusions on whether the garment fits him/her (i.e., too loose or too tight). Such reviews may seem contradicting and therefore perplex the third person who intends to rely on the reviews of others who have the same body measurements as his/hers.

Similarly, the P2P consumer review system may prevent one (consumers, sponsored bloggers, computer generated fake accounts, etc.) from writing untruthful reviews on clothes or shoes that conflict with his or her profile (including the past purchasing experience). For example, if one reviewer, who has been favoring casual and comfortable footwears and with little record of purchasing any heels, raves about a pair of 4″ high heels, the review will be given low credibility in the P2P consumer review system. A reviewer, who writes positive reviews for any and every product and therefore has no distinct features or styles, may also be deemed as having low credibility by the P2P consumer review system. Therefore, such reviews are excluded from the correlation analysis Thus, the P2P consumer review system may significantly reduce the chance of someone being misguided by untruthful reviews.

The P2P consumer review system may further be used as an advertisement platform that may help sellers find the right buyers, and vice versa. Unlike conventional online advertisement systems that use consumers' search/browsing history or market survey to advertise through emails, search engines, social media, and other advertisement channels, the P2P consumer review system may allow sellers to describe the features of their products and/or services. These features will be matched to the consumer attributes without exposing the consumers information (overall profiles) to the sellers. When consumers with a given set of attributes search for a product, the P2P consumer review system may show these consumers similar products from these sellers, with a higher likelihood, compared to traditional content matching, that the consumers may buy the sellers' products. This is a more efficient matching system for both buyers and sellers because it reduces unwanted or wasted advertisement, reduces the time for product searching and trying, and minimizes the influence of untruthful advertising.

The P2P consumer review system may also be an incentive system that motivates consumers to write truthful reviews because the truthful reviews serve two important purposes. First, a reviewer's truthful reviews help to train the machine learning algorithm to better profile the reviewer, thereby matching the reviewer with relevant products and/or services that the reviewer is more likely to buy in the future. Second, the reviewer's truthful reviews help other consumers that the machine learning algorithms match to the reviewer's profile to better understand products and/or services reviewed by the reviewer, with an increased likelihood that the matched consumers will buy one or more of the reviewed products and/or services. The P2P consumer review system thus may enable sellers to link successful sales to the contributing reviewers and offer rewards (e.g., cash, coupons, discounts, points, etc.) to the latter, rather than a blind reward to anyone who simply endorses the product or service. This is beneficial to the sellers because an untruthful endorsement may promote a short-term sale, but it does not sustain sales. Deceived buyers may choose to return the product or leave a more negative review due to being misguided. High rate of product return increases business cost. Negative reviews hurt future sales, when the negativity is caused by an unfitted product instead of a bad product. Sellers currently reward professional bloggers who have a large number of followers as a form of advertisement. However, as mentioned earlier, sponsored bloggers do not always provide truthful reviews because they are more like salespersons with commission fees. Buyers may not be able differentiate a product review from a product advertisement in review format. With a distributed review and reward system, every consumer may be rewarded if his or her review contributes to a successful purchase by another consumer. This P2P consumer review system may also help manufacturers, sellers, and service providers to better understand which characteristics of their products or services correlate to which consumer profiles and improve their products/services or marketing strategies accordingly

Using apparel as an example, when an online shopper searches for black boots, the P2P consumer review system may find black boots that are highly valued by those who have similar consumer profiles, considering fitting, design, material, price, etc. If the end result of one or more reviews is a successful purchase of one of the reviewed black boots (e.g., the online shopper purchases one of the reviewed black boots and/or does not return them within the allowed return period), the matched reviewer(s) may receive credits in the system and/or may be rewarded by the seller (e.g., either directly from the seller or via the P2P consumer review system).

While the reward structure motivates buyers to write positive reviews, it also motivates them to write negative reviews when products turn out not to be a good fit. The P2P consumer review system may include such a negative review in the corresponding consumer's purchase history to further refine the consumer's profile, which will contribute to better subsequent consumer matching and successful purchases, thereby increasing the likelihood of being rewarded. The P2P consumer review system is independent of the seller's merchandise system and gives no control to sellers to influence the reviews. Thus, the P2P consumer review system may give consumers more confidence in the products that they consider and may reduce the chance of returns.

The P2P consumer review system may further provide an effortless feedback gathering platform. Unlike conventional review methods that capture reviews that reflect a snapshot of one's opinion typically generated at the beginning or end of a product or service life, the P2P consumer review system may capture consumers' opinions about products or services over the lifetime of the products or the services. Consumers' opinions about products or services may change over time, but most consumers do not write multiple reviews or modify their reviews when their opinions change because there is no motivation to do so The P2P review system provides such a motivation because continuing feedback helps a consumer to refine his or her profile to not only earn rewards but also help himself/herself find better matched products.

The P2P consumer review system may include a feedback gathering platform. The feedback gathering platform may make product review effortless and truthful by integrating a feedback process with one's daily life when a product or a service is being used. Taking garments as an example, the P2P consumer review system may collect feedback from a consumer when he/she wears the garment. In addition to collecting subjective opinions (e.g., “Does it fit? Do you feel confident? Do you feel comfortable?”), the feedback gathering platform may also consider the context under which the product or service is being used (e.g., weather data (through weather services and based on geolocation) and event (through one's calendar or direct inputs)). Feedback may be collected multiple times throughout a product or service life to form a comprehensive review of the product or service performance under different circumstances and under wear and tear. All feedback that ties to personal life or information may be converted to general product feedback without revealing any personal information to protect privacy.

The feedback gathering platform may also be used to provide personal assistance, such as “what should I wear today?” The platform may help choose an outfit based on the weather, occasion, and feedback from the past experiences. The platform may also make a corresponding shopping recommendation if one seems to miss a garment to complete the look that he or she wants or needs.

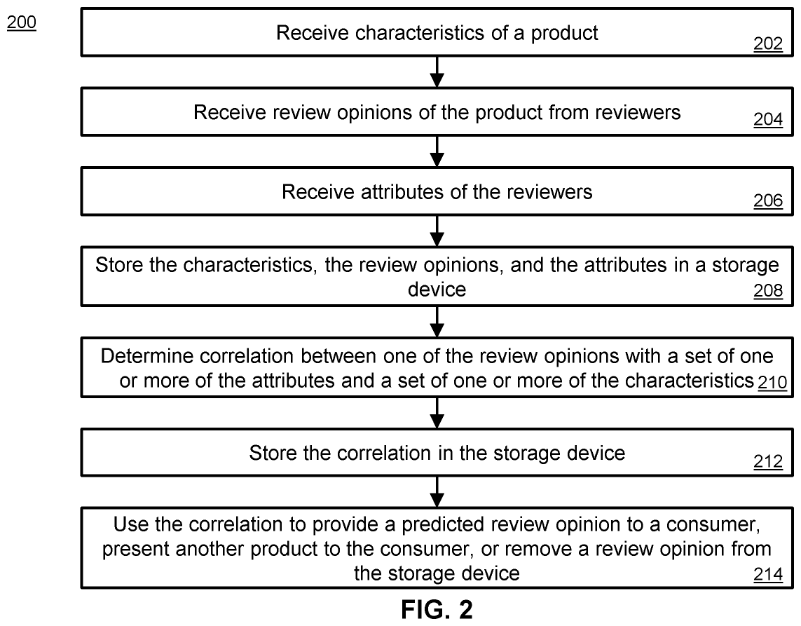

FIG. 2 shows a flow diagram of a peer-to-peer consumer review method 200 according to embodiments of the present disclosure. At step 202, the method 200 receives characteristics of the product. At step 204, the method 200 receives review opinions of the product from reviewers. At step 206, the method 200 receives attributes of the reviewers. At step 208, the method 200 stores the characteristics, the review opinions, and the attributes in a storage device. At step 210, the method 200 determines a correlation between one of the review opinions with a set of one or more of the attributes and a set of one or more of the characteristics. At step 212, the method 200 stores the correlation in the storage device. At step 214, the method 200 uses the correlation to provide a predicted review opinion to a consumer, present another product to the consumer, or remove a review opinion from the storage device.

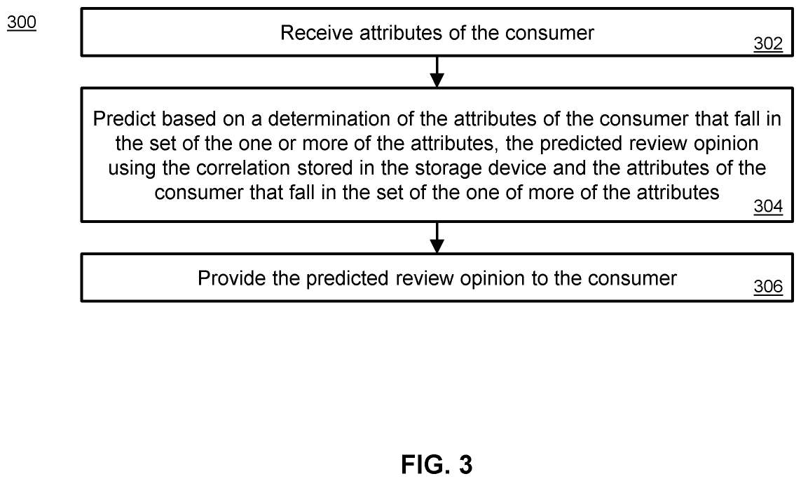

FIG. 3 shows a flow diagram of a peer-to-peer consumer review method 300 according to embodiments of the present disclosure. The method 300 may proceed from the method 200. At step 302, the method 300 receives attributes of the consumer. At step 304, the method 300 predicts, based on a determination of the attributes of the consumer that fall in the set of the one or more of the attributes, the predicted review opinion using the correlation stored in the storage device and the attributes of the consumer that fall in the set of the one of more of the attributes. At step 306, the method 300 provides the predicted review opinion to the consumer.

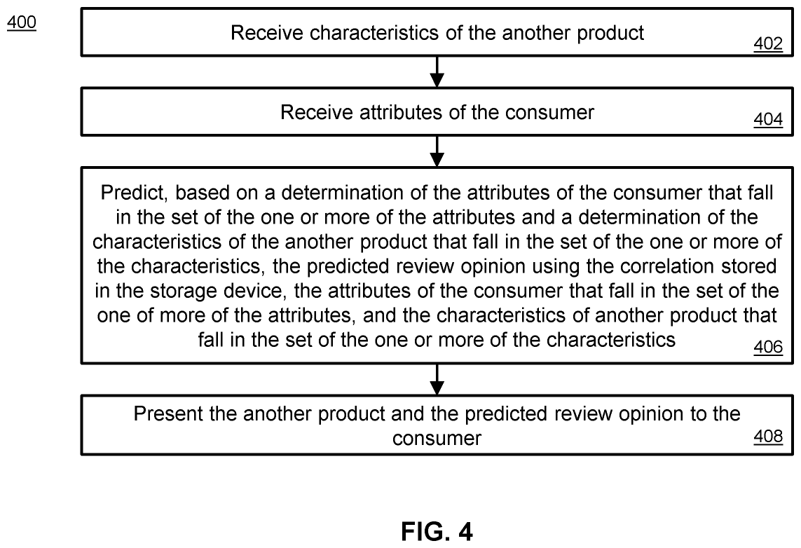

FIG. 4 shows a flow diagram of a peer-to-peer consumer review method 400 according to embodiments of the present disclosure. The method 400 may proceed from the method 200. At step 402, the method 400 receives characteristics of the another product. At step 404, the method 400 receives attributes of the consumer. At step 406, the method 400 predicts, based on a determination of the attributes of the consumer that fall in the set of the one or more of the attributes and a determination of the characteristics of the another product that fall in the set of the one or more of the characteristics, the predicted review opinion using the correlation stored in the storage device, the attributes of the consumer that fall in the set of the one of more of the attributes, and the characteristics of another product that fall in the set of the one or more of the characteristics. At step 408, the method 400 presents the another product and the predicted review opinion to the consumer.

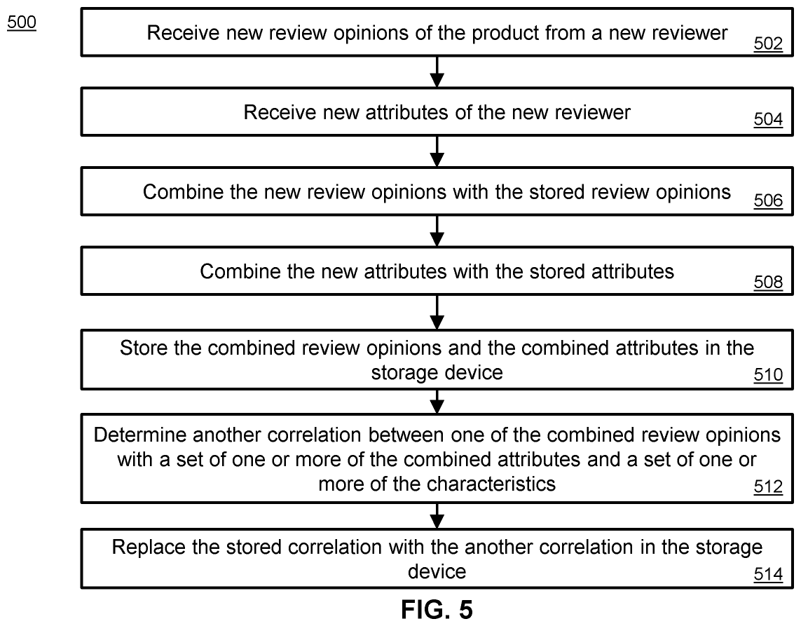

FIG. 5 shows a flow diagram of a peer-to-peer consumer review method 500 according to embodiments of the present disclosure. The method 500 may proceed from the method 200. At step 502, the method 500 receives new review opinions of the product from a new reviewer. At step 504, the method 500 receives new attributes of the new reviewer. At step 506, the method 500 combines the new review opinions with the stored review opinions. At step 508, the method 500 combines the new attributes with the stored attributes. At step 510, the method 500 stores the combined review opinions and the combined attributes in the storage device. At step 512, the method 500 determines another correlation between one of the combined review opinions with a set of one or more of the combined attributes and a set of one or more of the characteristics. At step 514, the method 500 replaces the stored correlation with the another correlation in the storage device.

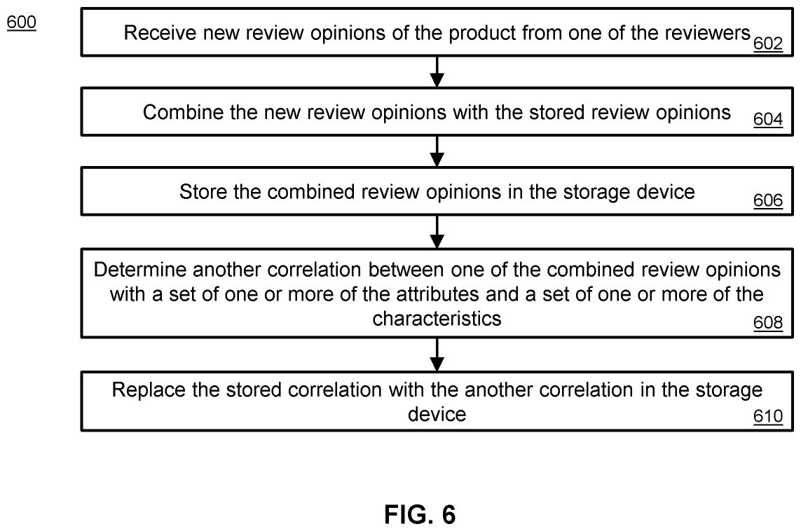

FIG. 6 shows a flow diagram of a peer-to-peer consumer review method 600 according to embodiments of the present disclosure. The method 600 may proceed from the method 200. At step 602, the method 600 receives new review opinions of the product from one of the reviewers. At step 604, the method 600 combines the new review opinions with the stored review opinions. At step 606, the method 600 stores the combined review opinions in the storage device. At step 608, the method 600 determines another correlation between one of the combined review opinions with a set of one or more of the attributes and a set of one or more of the characteristics. At step 610, the method 600 replaces the stored correlation with the another correlation in the storage device.

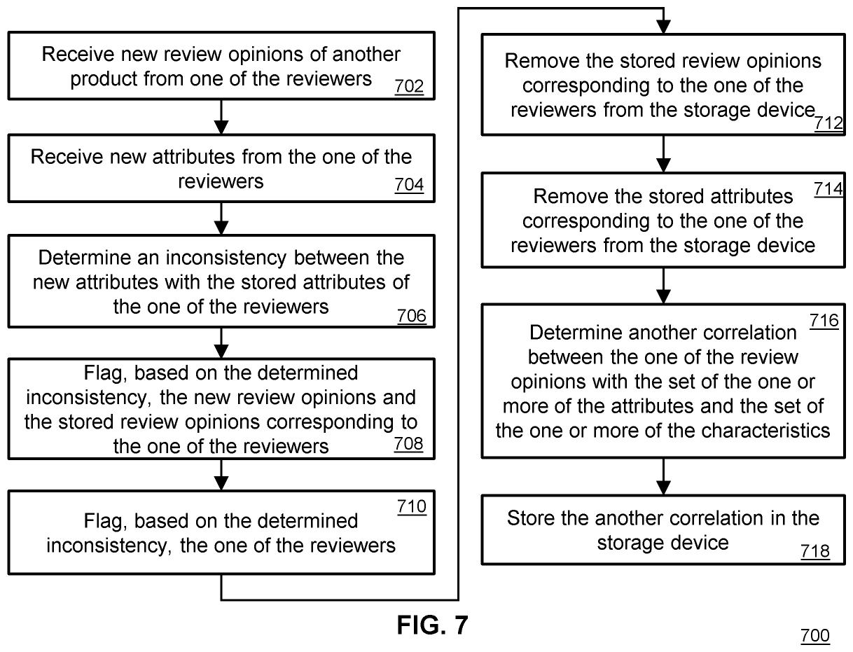

FIG. 7 shows a flow diagram of a peer-to-peer consumer review method 700 according to embodiments of the present disclosure. The method 700 may proceed from the method 200. At step 702, the method 700 receives new review opinions of another product from one of the reviewers. At step 704, the method 700 receives new attributes from the one of the reviewers. At step 706, the method 700 determines an inconsistency between the new attributes with the stored attributes of the one of the reviewers. At step 708, the method 700 flags, based on the determined inconsistency, the new review opinions and the stored review opinions corresponding to the one of the reviewers. At step 710, the method 700 flags, based on the determined inconsistency, the one of the reviewers. At step 712, the method 700 removes the stored review opinions corresponding to the one of the reviewers from the storage device. At step 714, the method 700 removes the stored attributes corresponding to the one of the reviewers from the storage device. At step 716, the method 700 determines another correlation between the one of the review opinions with the set of the one or more of the attributes and the set of the one or more of the characteristics. At step 718, the method 700 stores the another correlation in the storage device.

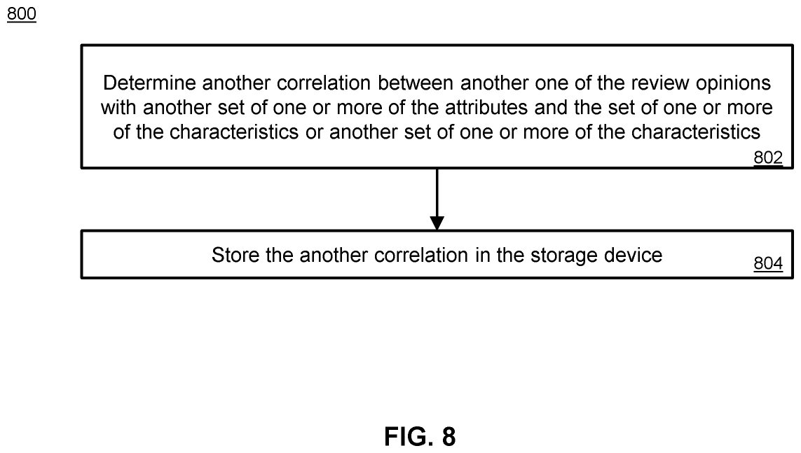

FIG. 8 shows a flow diagram of a peer-to-peer consumer review method 800 according to embodiments of the present disclosure. The method 800 may proceed from the method 200. At step 802, the method 800 determines another correlation between another one of the review opinions with another set of one or more of the attributes and the set of one or more of the characteristics or another set of one or more of the characteristics. At step 804, the method 800 stores the another correlation in the storage device.

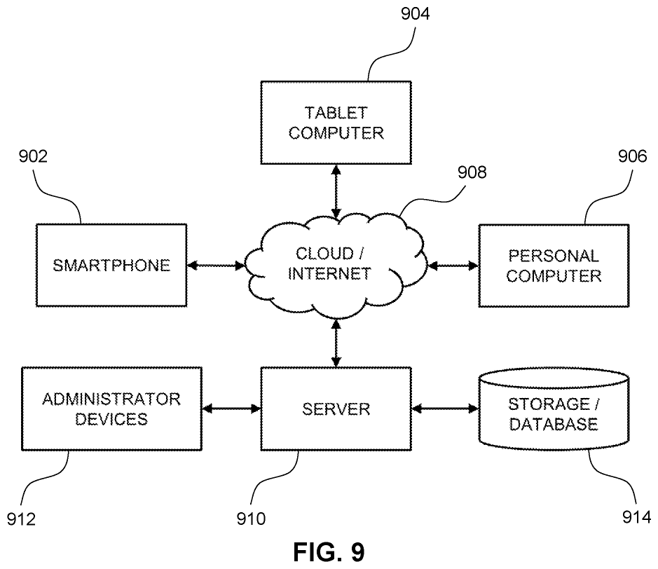

The P2P consumer review system may be implemented as illustrated in FIG. 9. On the frontend, consumers may access the P2P consumer review system using one or more user devices such as a smartphone 902, a tablet computer 904, and a personal computer 906. The consumers may access the P2P consumer review system via applications (“apps”) or any appropriate software installed on the user devices. The applications or software may access the P2P consumer review system via the Internet (“cloud”) 908. On the backend, the P2P consumer review system may reside on a server 910, which is accessible from the Internet or via a local area network (LAN) by one or more administrator devices (e.g., computers) 912. One or more administrators may be responsible for maintaining and updating the P2P consumer review system on the server. Consumer profiles, reviews, and feedback, products and services characteristics, correlations generated by the P2P consumer review system may be stored in one or more databases in one or more storage devices 914 that are accessible by the server 910.

Each of the smartphone 902, tablet computer 904, the personal computer 906, the server 910, and the administrator device 912 may include one or more of a processor, memory, a user interface, a communication interface, and a file system. The processor may be configured to execute computer-readable instructions (such as software) that are provided from, for example, a non-transitory computer-readable medium. For example, the server 910 may include a processor configured to execute computer instructions from a non-transitory computer-readable medium to perform the methods 200-800 described above. The memory can be a transitory or non-transitory computer-readable medium, such as flash memory, a magnetic disk, an optical disk, a programmable read-only memory, or any other memory or combination of memories. The memory may also store instructions that may be executed by the processor. For example, the server 910 may include memory storing instructions that may be executed by the processor to perform the methods 200-800 described above.

The present disclosure is not limited in scope by the specific embodiments described herein. Other embodiments of and modifications to the present disclosure, in addition to those described herein, will be apparent to those of ordinary skill in the art from the foregoing description and accompanying drawings. Such other embodiments and modification are intended to fall with the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. For instance, it is understood that the peer-to-peer review techniques described herein are not limited to clothes and shoes. Rather, this invention applies widely to any product (e.g., apparels, electronics, vehicles, personal care, etc.) or service (e.g., food services, fitness, beauty service, etc.).

What is claimed is:

1. A peer-to-peer consumer review method comprising:
receiving, by a system comprising memory and one or more processors, characteristics of the product;
receiving, by the system, review opinions of the product from reviewers;
receiving, by the system, attributes of the reviewers;
storing, by the system, the characteristics, the review opinions, and the attributes in a storage device;
determining, by the system, a correlation between one of the review opinions with a set of one or more of the attributes and a set of one or more of the characteristics;
storing, by the system, the correlation in the storage device; and
using, by the system, the correlation to provide a predicted review opinion to a consumer, present another product to the consumer, or remove a review opinion from the storage device.

2. The peer-to-peer consumer review method of claim 1, further comprising:
receiving, by the system, attributes of the consumer;
predicting, by the system and based on a determination of the attributes of the consumer that fall in the set of the one or more of the attributes, the predicted review opinion using the correlation stored in the storage device and the attributes of the consumer that fall in the set of the one of more of the attributes; and
providing, by the system, the predicted review opinion to the consumer.

3. The peer-to-peer consumer review method of claim 1, further comprising:
receiving, by the system, characteristics of the another product;
receiving, by the system, attributes of the consumer;
predicting, by the system and based on a determination of the attributes of the consumer that fall in the set of the one or more of the attributes and a determination of the characteristics of the another product that fall in the set of the one or more of the characteristics, the predicted review opinion using the correlation stored in the storage device, the attributes of the consumer that fall in the set of the one of more of the attributes, and the characteristics of another product that fall in the set of the one or more of the characteristics; and
presenting, by the system, the another product and the predicted review opinion to the consumer.

4. The peer-to-peer consumer review method of claim 1, further comprising:
receiving, by the system, new review opinions of the product from a new reviewer;
receiving, by the system, new attributes of the new reviewer;
combining, by the system, the new review opinions with the stored review opinions;
combining, by the system, the new attributes with the stored attributes;
storing, by the system, the combined review opinions and the combined attributes in the storage device;
determining, by the system, another correlation between one of the combined review opinions with a set of one or more of the combined attributes and a set of one or more of the characteristics; and
replacing, by the system, the stored correlation with the another correlation in the storage device.

5. The peer-to-peer consumer review method of claim 1, further comprising:
receiving, by the system, new review opinions of the product from one of the reviewers;
combining, by the system, the new review opinions with the stored review opinions;
storing, by the system, the combined review opinions in the storage device;
determining, by the system, another correlation between one of the combined review opinions with a set of one or more of the attributes and a set of one or more of the characteristics; and
replacing, by the system, the stored correlation with the another correlation in the storage device.

6. The peer-to-peer consumer review method of claim 1, further comprising:
receiving, by the system, new review opinions of another product from one of the reviewers;
receiving, by the system, new attributes from the one of the reviewers;
determining, by the system, an inconsistency between the new attributes with the stored attributes of the one of the reviewers;
flagging, by the system and based on the determined inconsistency, the new review opinions and the stored review opinions corresponding to the one of the reviewers;
flagging, by the system and based on the determined inconsistency, the one of the reviewers;
removing, by the system, the stored review opinions corresponding to the one of the reviewers from the storage device;
removing, by the system, the stored attributes corresponding to the one of the reviewers from the storage device;
determining, by the system, another correlation between the one of the review opinions with the set of the one or more of the attributes and the set of the one or more of the characteristics; and
storing, by the system, the another correlation in the storage device.

7. The method of claim 1, further comprising:
determining, by the system, another correlation between another one of the review opinions with another set of one or more of the attributes and the set of one or more of the characteristics or another set of one or more of the characteristics; and
storing, by the system, the another correlation in the storage device.

8. The method of claim 1, wherein the product is one of an apparel, a service, a hardware, and a vehicle.

9. The method of claim 1, wherein the attributes of the reviewers include one or more of gender, age, body measurements, ethnicity, cultural background, lifestyle, and spending habit.

10. The method of claim 1, wherein the characteristics of the product include one or more physical dimensions, shape, color, functions, electrical ratings, mechanical ratings, and firmness.

11. The method of claim 1, wherein the review opinions include one or more of fit, big, small, tight, loose, long, short, high-quality, low quality, and comfortable.

12. A peer-to-peer consumer review system comprising:
one or more processors; and
memory storing instructions that, when executed by the one or more processors, cause the peer-to-peer consumer review system to:
receive characteristics of the product;
receive review opinions of the product from reviewers;
receive attributes of the reviewers;
store the review opinions, and the attributes in a storage device;
determine a correlation between one of the review opinions with a set of one or more of the attributes and a set of one or more of the characteristics;
store the correlation in the storage device; and
use the correlation to provide a predicted review opinion to a consumer, present another product to the consumer, or remove a review opinion from the storage device.

13. A non-transitory computer-readable medium storing executable instructions that, when executed by one or more processors, cause a peer-to-peer consumer review system to:
receive characteristics of the product;
receive review opinions of the product from reviewers;
receive attributes of the reviewers;
store the review opinions, and the attributes in a storage device;
determine a correlation between one of the review opinions with a set of one or more of the attributes and a set of one or more of the characteristics;
store the correlation in the storage device; and
use the correlation to provide a predicted review opinion to a consumer, present another product to the consumer, or remove a review opinion from the storage device.
